(19) United States
(12) Patent Application Publication
(10) Pub. No.: US 2007/0102877 A1
(43) Pub. Date: May 10, 2007

(54) Apparatus and methodology for sports square wagering

(76) Inventors: James M. Personius, Fort Lauderdale, FL (US); Joseph Loconte, Arlington Heights, IL (US)

Correspondence Address: John D. Long;PATENT COUNSEL, 2941 Sage Ridge Drive, Reno, NV, 89509, US

(21) Appl. No.: 11/232,759

(22) Filed: Nov. 2, 2005

(51) Int. Cl. A63F 9/24; G06F 19/00; A63B 71/00

(52) U.S. Cl. 273/138.2; 463/28; 463/16

(57) ABSTRACT

One possible embodiment of the invention could substantially be a system and methodology for a pari-mutuel form of sports square wagering, which may utilize a wager format and a wager processing center. The wagering format, having paper and electronic forms, could be used to communicate wagering information to the wager processing center. The wager format may have a wager entry means, which could be grid having gaming squares through which the gambler could record or otherwise denote the gambler's selection of one or more potential winning occurrence(s). The wager processing center could be an institution generally comprising of the capability of receiving and handing of wagers and a common wager pool into which wagered funds are placed and from which winning wagers are paid

### CROSS-REFERENCES TO RELATED APPLICATIONS/DOCUMENTS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND

1. Field of the Invention

The present invention generally relates to the field of sports square wagering and in particular to sports square gambling which may embody one or more aspects of pari-mutuel wagering.

2. Background of the Invention

The inclination of humans to generally engage in and generally enjoy gambling (and as known in polite circles as gaming) has generally been known to exist since prehistoric times. During various periods in the history of the United States, various government bodies treated gambling as less than desired social conduct of the masses that needed to be curbed or otherwise restricted in some manner or the other. The application of such governmental gambling restrictions generally grew in the late nineteenth/early twentieth century when the wide spread proliferation of new gaming devices such as the slot machine and other gambling inventions generally heightened the interest and participation of both the public and the criminal underworld in gambling and various events surrounding gambling. Accordingly, various government entities (such as those in the United States) wishing to curb criminal underworld's participation in gambling activities, generally began to restrict, or prohibit altogether, gambling with few exceptions. In many instances, many governments in the United States had extensively regulated gambling to the point of nationwide prohibition, with the notable exceptions of the States of Nevada and New Jersey.

In recent years, however, there has been a renewed interest by the public in gambling activities, generally followed by a nationwide trend by numerous governmental entities to reduce gambling restrictions to point of actually legalizing various forms of gambling so as to possibly provide badly needed taxable revenue and economic stimulus. Further, with the creation of the Internet and the gambling offerings provided by it, the public's interest in new and old forms of gambling has increased substantially.

One of the forms of gambling that the public and their respective government entities have been interested in is that of pool based gambling. In this form of gambling, all the wagers (e.g., bets) may be generally placed into a common wager pool (e.g., a pot, a bank, an account, and the like) with the winners of that gambling activity generally being paid out from that common wager pool. Of all the forms of pool-based gambling, pari-mutuel gambling may be generally considered to be the best known and successful.

In pari-mutuel gambling, only the participating gamblers, not the organization running the gambling event (i.e., the “house” such as a casino and the like), are generally allowed to contribute money to the common wager pool. This pooling of collected wagers leads to one of the distinct characteristics of pari-mutuel gambling in that the participating gamblers (e.g., rather than the house) generally determines the payoff odds. The odds for the payout or payoff of the winning wagers may be calculated by dividing the pari-mutuel common wager pool among all placed bets, and then generally rounding odds off to a denomination generally set by gambling industry standards, governmental regulations, or the like. Generally speaking, the fewer winning bets in relation to the entire pool, the greater the payouts on the individual winning wager payout(s). Conversely, if many gamblers have made winning bets, then the individual payoffs of the winning bets may be low, simply because there are more winners to generally divide up the common wager pool. Since the odds are generally determined by the number of gamblers betting on an event at any given time, machines such as totalizators (e.g., high speed tabulators or calculators) have generally been developed to generally record and post or display up-to-the-minute odds.

Pari-mutuel gambling may be further characterized by the general prohibition of the house from participating in the wagering. Another possible characteristic could be the general prohibition of the house from placing initial or “seed” money in the pool to start the pool. To allow the house to generally make some income for sponsoring and otherwise handling the business aspects of the pari-mutuel gambling events, the government regulating the gambling may permit the house to take a service fee (e.g., a fixed proportion of the wagered pool) prior to the payout of winning wagers. This service fee could be used for payment of the house's expenses in running the gambling event; the payment of the house's profit; the payment of government taxes on the amount gambled; the payment for other governmental approved appropriations; and the like. Outside of the service fee, generally the remaining collected wagered funds of the common wager pool are paid out as winning wagers.

Due to very limited house participation in the wagering, many governmental entities, such as the various state governments of the United States, may generally believe that pari-mutuel forms of gambling generally 1) substantially curtail the occurrence of corruption (e.g., the occurrence of criminal activities in both private and public sector); 2) provide a very controllable (by the state) form of gambling; and 3) may act as a “firebreak” deterrent to other forms of gambling considered illegal in their jurisdictions. These reasons may be why some governments, which otherwise generally prohibit gambling (such as casino-type gambling), may allow the presence of pari-mutuel gambling within their jurisdictions. These reasons could also be the basis why some governments may allow pari-mutuel gambling to be one of the few forms of gambling allowed at “off track” facilities, where wagering can generally occur without the players generally being present at the actual events being betted upon.

Typically, pari-mutuel gambling, wagering, betting and the like may sometimes played in conjunction with certain activities, which generally features both a short completion time and a ranking of the event's winning participants. Such activities that have traditionally availed themselves to the pari-mutuel gambling included horse racing, dog racing, and jai alai.

Pari-mutuel gambling traditionally has also afforded several types of wagering or betting on an event in which each type of wagering has its own common wager pool. The basic pari-mutuel wagering generally involves predicting the order of finish for a single participant in betted upon event: Win picks the first place finisher; Place picks the second place finisher; and Show picks the third place finisher.

Other types of pari-mutuel wagering, generally known in the gambling trade as “exotics”, may also be offered. These wagers, depending on the rules may allow the gambler to bet on the finish of more than one sporting participant, or more than one event. These “exotic” wagers generally provide for higher payoffs and greater house takes and may include the following: Exacta: picks the first and second place finisher, in the correct order; Quinella: picks the first and second place finisher, but the order doesn't matter; Trifecta: picks the first, second, and third place finisher, in the correct order; Daily Double: picks the first place finisher in two straight events; and Pick Six: picks the winner in six consecutive events.

Another form of gambling is sports squares (e.g., football squares). Sports squares wagering, unlike pari-mutuel gambling, my be restricted or otherwise prohibited in many jurisdictions. In sports square gambling, the gamblers may place the wagers upon a selected sporting event (e.g., a particular football game or the like), which may feature a plurality of teams. In such a wagered upon sporting event, the winning of the sporting event and hence the winning of the wagers may be determined based on a ranking of scores produced by each team during the selected sporting event according to the sporting event's rules and regulations.

To place a sports squares wager(s), the gambler's wagering information (e.g., gambler's identification information, selection of the winning score(s) and corresponding wager amounts) could be recorded on a sports squares wager card that generally has a representation of a grid having an x and a y axes at substantially mutual perpendicular orientation generally forming the gaming squares, a plurality of which may be used to represent various potential winning scores or results for the sporting event. The numerations for one half of the possible scores (e.g., for one team) is plotted on one axis (e.g., a vertical or x-axis) while the numerations for the other half of possible scores (e.g., for another team) may be plotted on the other axis (e.g., a horizontal or y-axis). In this manner, the resulting intersections of the formed rows and columns of the grid may form gaming squares, which individually may represent potential winning sports scores through the assigned numeration. The gaming squares may in some instances further list the odds (e.g., preset/predetermined by the house) for the possibility of particular sports score occurring for that sporting event. Generally, only one gaming square on the grid could represent a potential final winning score which could be the actual final winning score for the wagered upon sporting event.

A gambler, in placing his or her wager, could designate one or more gaming squares in the grid that he or she believes represents the ultimate winning score for the wagered upon sporting event (e.g., a professional football game). The gambler then places the sports square wager(s) (e.g., the filled out or otherwise marked wager card and the wagered finds) with the gaming institution (e.g., the house) running the sports square gambling event.

Sports square gambling, unlike pari-mutuel gambling, generally does not place the accumulated wagers into, or payout winning wagers out from, a common wager pool. The downside to this form of gambling is that the amount of the placed wagers might be inadequate to pay out the winning payouts (as determined by house set odds). The house, in such an instance, could be liable for the winning wagers and therefore have to use its own financial resources (other than the wages taken in) to make the complete payout of winning wagers. The upside is that the house may be able to make a greater profit from running such gambling because it could be able to keep all the taken in wagers which are not given back as payout. The winning payout could be, in at least one instance, the amount of the original wager increased by the preset odds listed on the winning square. Generally speaking, in jurisdictions where casino gambling is not is allowed, football square and other sports square gambling are also prohibited.

What is needed therefore is a format and methodology which may combine various aspects of sports square gambling with various aspects of pari-mutuel gaming to provide a new and exciting form of wagering that increases and encourages participation in gaming. Such a gambling methodology and apparatus, in at least one embodiment, could provide various aspects of pari-mutuel gambling which are palatable to the government, thus encouraging those other gambling restricting jurisdictions to permit the operation of the new gambling methodology for sports squares, which in turn could benefit the jurisdiction by providing for an increased tax revenue base, an additional economic stimuli, and an effective crime fighting tool to combat corruption and illegal gambling.

### SUMMARY OF THE INVENTION

### Advantages of One or More Embodiments of the Present Invention

The various embodiments of the present invention may, but do not necessarily, achieve one or more of the following advantages:

the ability to allow sports square gambling to become acceptable to those jurisdictions that allow only pari-mutuel gambling;

the ability to allow the reduction of the risk of insufficient payout by the house in sports square gambling;

the ability to increase the variations and playing enjoyment for sports square gambling;

the ability to form an acceptable legal gaming activity to those governmental authorities that normally could not allow the presence of gambling activities within their jurisdictions; and

to provide those jurisdictions with an increased tax revenue base, an additional economic stimuli, and an effective tool to combat illegal gambling.

These and other advantages may be realized by reference to the remaining portions of the specification, claims, and abstract.

### Brief Description of One Embodiment of the Present Invention

One embodiment of the invention could a process for sports square wagering comprising presenting a grid comprised of a plurality of gaming squares, the gaming square representing a potential winning occurrence for a wagered upon sporting event; selecting at least one gaming square; transmitting wagered funds to a common wager pool based upon the at least one selected gaming square; determining that at least one winning selected gaming squares; and issuing the calculated payouts from the common wager pool as the winning wagers.

One embodiment of the invention could be a system for sports square wagering comprising of a wager format, the wager format with a display showing least one grid forming a plurality of gaming squares, each gaming square representing a potential winning event for the wagered upon sporting event; selected gaming squares transmit wager information to a wager processing capability; and the wager processing center, the wager processing center comprising of at least one a common wager pool for receiving finds from wagers placed upon the wagered upon sport; the ability to determine winning wagers; and the ability to issue payouts from the common wager pool for winning wagers based on selected gaming squares.

One embodiment of the invention could be an apparatus for sports square gambling comprising a wager format means for communicating wagers placed a wagered upon sporting event using a grid which displays gaming squares representing potential winning events of the wagered upon sporting event; a process means for the collection of placed wagers and the tabulation of winning wagers; and a common wager pool means for holding wagered funds and for paying out of winning wagers.

The above-description sets forth, rather broadly, a summary of at least one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 is substantially a relational schematic for one possible embodiment of the invention.

FIG. 1A is substantially a view of one possible version of a wager format for an American Football Pool Mania embodiment of the invention.

FIG. 2 is substantially a view of one possible version of a wager format for a Roulette embodiment of the invention.

FIG. 3 is substantially a view of one possible version of a wager format for a Touching Squares embodiment of the invention.

FIG. 4 is substantially a view of one possible version of a wager format for a Final Score embodiment of the invention.

FIG. 5 is substantially a view of one possible version of a wager format for a Winner Selection embodiment of the invention.

FIG. 6 is substantially a view of one possible version of a wager format for a Boxing embodiment of the invention.

FIG. 7 is substantially a view of a possible wager format for a Baseball embodiment of the invention.

FIG. 8 is substantially a view of a possible wager format for a 13-Runs Baseball embodiment of the invention.

FIG. 8A substantially a view of a possible wager format for a 13-Run Baseball embodiment of the invention.

FIG. 9 is substantially a view of a one possible version of a wager format for a No-Hitter Baseball embodiment of the invention.

FIG. 9A is substantially a view of possible version of a wager format for a No-Hitter Baseball embodiment of the invention

FIG. 10 is substantially a view of one possible version of a wager format for a Jackpot embodiment of the invention.

FIG. 11 is substantially a view of one possible version of a wager format for a Points Edition of the embodiment of the invention.

FIG. 12 is substantially a schematic flow chart for one possible process embodiment for the invention.

### DETAILED DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. The paragraph headings herein are inserted as a matter of convenience and for reference and in no way define or limit the scope of the invention as claimed or described.

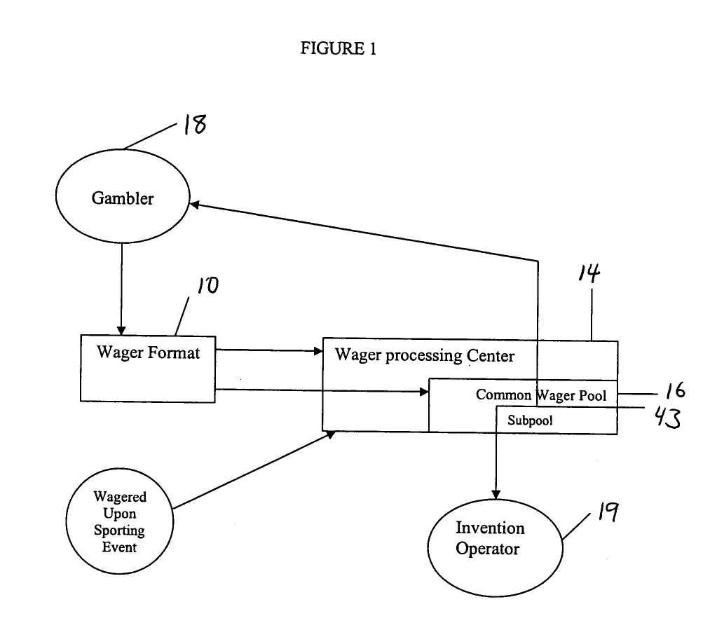

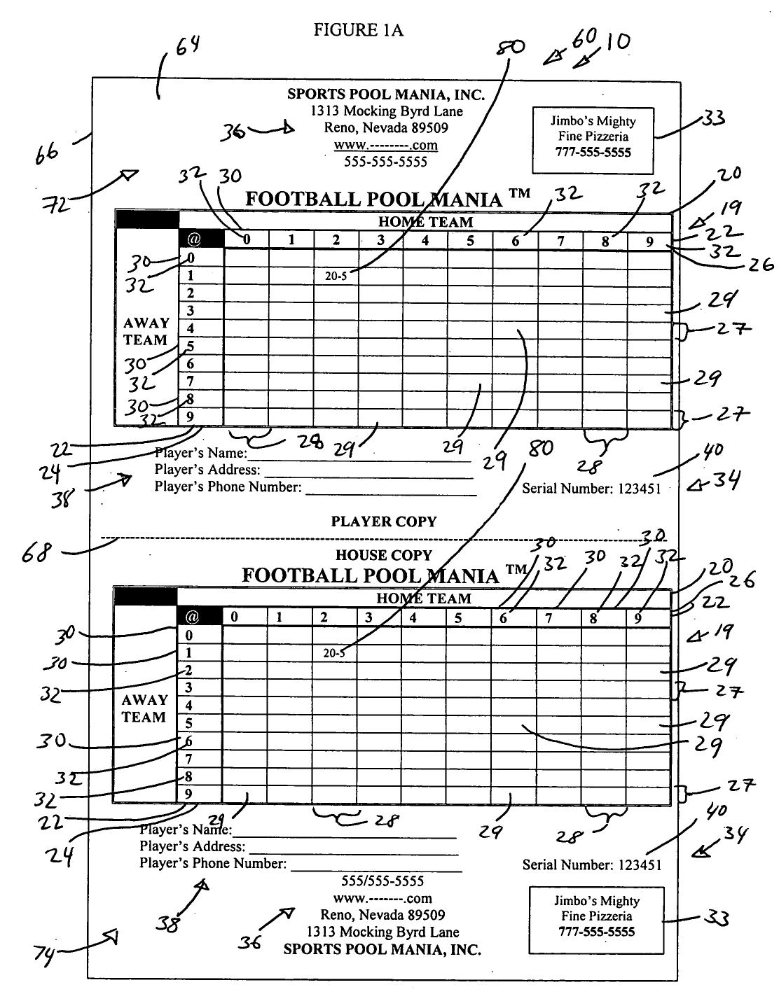

As generally shown in FIGS. 1 and 1A, one embodiment of the present invention could encompass a methodology and apparatus for generally providing for a pari-mutuel form of sports square gambling or gaming. The invention and its various embodiments and protocols could also encompass a wide number of sporting events for both individual and team sports, including, but not limited to, football, baseball, hockey, basketball, swimming, tennis, auto racing, motorcycle racing, bicycle racing, golf, bowling, rodeo, Olympic events, Australian football, soccer/football, rugby, cricket, billiards, pool, and the like. The invention could focus on wagering upon the final winning conclusion (e.g., the final winning score) of a particular sports event, contest, game or the like (e.g., a professional football game, etc.) as well as include wagering on the outcome of various sub-events (e.g., a pre-final score; the occurrence of certain maneuvers, a certain player's game performance, etc.) that may or may not occur during the wagered upon sporting event.

The invention could comprise at least of one wager format 10 and at least one wager processing center 14, wherein the wager format 10 may be a gambler's user interface with the wager processing center 14 for the communication of sports square wagers placed by the gambler. In some embodiments, the wager format 10 may also be used to facilitate the payout of the winning wager(s) to winning gambler(s) as well.

The invention operator 18 (e.g., a gambling establishment running the wagering and hence running the wager processing center 14) could initially provide the gambler 17 with access to the wager format 10 for the entry of wager data into the wager format 10. In at least one embodiment, several different sets of wager formats 10 could be presented and operated by the invention operator 18 simultaneously with each set being generally associated with a different wagered-upon sporting event (e.g., one set of wager formats 10 could be associated with a Chicago Bears-Green Bay Packers football game while another set of wager formats 10 could be issued for a New England Patriots-New York Giants game). Once the wager data is substantially entered by the gambler 17 using the wager format 10, the wager data along with the wagered upon funds may be transferred to the wager processing center 14. At the wager processing center 14, the wagered funds may be held in a common wager pool 16 while the wager data for all placed bets for the wagered upon event are processed. This processing may include the calculation of potential payouts (e.g., the payout odds) for the winning wagers. After the close of wagering for the wagered upon event, a fixed percentage of the common wager pool 16 may be removed or otherwise held aside for payment to the invention operator 18 for operating the invention. After the wagered upon event occurs or is otherwise decided, the wager processing center 14 calculates the actual payouts and makes the winning payouts from the remaining monies of the common wager pool 16 to the successful or winning gambler(s) 17 based upon the actual winning occurrence. The wager processing center 14 then could transfer the fixed percentage to the invention operator's account.

The wager format 10 could have a paper form (e.g., a paper wager card 60) or an electronic form (not shown), both of which could provide several data fields that could be used to communicate the gambler's wager information to the wager processing center 40. These data fields could include, but not be limited to a wager entry means 19 (used to handle the actual wager information), a playing communication means 34 (used to handle identification information pertaining to the gambler, invention operator and the like), and an advertising means 33 (used to present advertisement to the gambler 17). The wager entry means 19 could be the data field in which the gambler 17 could mark or otherwise designate his or her selection of one or more potential winning occurrences (e.g., a possible final score of a wagered upon sporting event). In one embodiment of the wager format 10, the wager entry means 19 could be a grid 20 forming a plurality of gaming squares 29 through which the gambler 17 could record or otherwise denote the gambler's selection of one or more potential winning occurrence(s) (e.g., a potential outcome for the wagered upon sporting event or some aspect or sub-event of the wagered upon sporting event). Each gaming square 29 could representing a different potential winning occurrence for a wagered upon sporting event. In at least one embodiment, the gaming square could present payout odds or bonus indicia 80 relating to the represented potential winning occurrence.

The playing communication means 34 could further comprise of several data sub-fields. These several data sub-fields could include, but not necessarily be limited to an invention operator's contact means 36 (e.g., a sub-field displaying the invention operator's identification and contact information); a wager format identification means 40 (e.g., a sub-field for displaying serial number, bar code and the like, which could be assigned to an individual wager format 10); and a gambler identification means 34 (e.g., a sub-field for accepting the gambler's identification and contact information to correctly identify a winning gambler 17 with his or her winning wager(s) and corresponding payout.)

The advertising means 33 could be a data entry field in which the invention operator 18 may communicate information to the gambler 17 about other goods and services that the invention operator may provide or that a third a party entity may provide.

At least one embodiment of the paper wager card 60 could be a rectangular-shaped paper card with a front side 64 and a back side 66. The front side could have a perforation 68 substantially dividing the paper wager card 60 laterally into a first section 72 and a second section 74. Each section may have duplicate data entry fields (e.g., the wager entry means 19, the playing communication means 34, the advertising means 33 and the like). The duplicate data fields substantially allow the gambler 17 to enter duplicate wager information and the like on both the first section 72 and the second section 74. The gambler 17 could then separate, along the perforation 68, the first section 72 from the second section 74. The first section 74 (and its wager information) could be used as the gambler's or player's copy (e.g., retained by the gambler 17 as a form of receipt for the placement of the wager.) The second section 76 could be designated as the house copy. The house copy or second section 76 (or just the wager information entered in on it) along with the wagered amount (funds, monies, credit and the like) may then may be transmitted to the wager processing center 14 for tabulation.

The electronic form (not shown), in at least one embodiment, that may present a visual presentation of the paper format (e.g., paper wager card 60) and be associated with a computer user interface connected to a computer network of the wager processing center 14 for electronic communication of the wager data (including wager receipt, payout of winning wagers, and the like) between the gambler 17 and the wager processing center 14. The electronic format could further provide for individual wagering to be conducted in areas generally remote from the wagered upon sporting event so that invention could be allowed in kiosks, sports bars, sporting venues, internet, restaurants and the like, outside the traditional off-track betting sporting events centers. Further, the electronic format may make it possible for electronic embodiments of the invention to have decentralized wager processing center 14 as well as allow localized wagering with increased pool size and larger payoffs.

The wager processing center 14 could be a system or an institution run by the invention operator 18, which generally deals with the collection, tabulation, processing and payout of the various sporting wagers placed using the invention. The wager processing center 14 could be generally akin to those systems or institutions employed by gaming establishments for the collecting, processing and payout of keno wagers, with the exception generally being that the present wager processing center 14 could utilize a common wager pool 16 for the placement of the collected wagers and the payout of the winning wagers. Further, the invention operator 18 generally could not be able to seed the common wager pool 16, could not fix payout odds, and could be limited to being only paid a fixed percentage from monies collected in the common wager pool 16 as payment for operating the invention.

Wager Format

As initially described above, the wager format 10 in various versions may have certain data fields or sub-fields. In at least one embodiment, one such data field could be the wager entry means 19 that could comprise of at least one grid 20 with at least two axes 22. The axes 22 could generally comprise of at least one vertical or x axis 24 and at least one horizontal or y axis 26. At least one embodiment of the wager format 10 (not shown) could display a representation of a three-dimensional image that could show a grid 20 with a third z axis.

The y-axis 26 could be assigned to one team (or sports player) participating in a wagered-upon sporting event while x-axis being assigned to competing team (or sports player) participating in that sporting event. Each axis 22 could be divided into a number of segments 30 with each segment 30 being assigned indicia 32 to indicate that assigned player's or team's potential winning occurrence or performance (e.g., a final winning score) that could occur during some point in the wagered upon event. For instance, where a particular professional football game is selected as the wagered upon event, each segment 30 could bear indicia 32 (e.g. a numeral) representing one half of the score for a team in the wagered upon football game. Each segment 30 (and its associated indicia 32) of the x or vertical axis could be assigned to a corresponding row 27 in the grid 20. Similarly, each of the segments 30 of the y or horizontal axis 26 could also be assigned a respective column 28 in the grid 20. The intersection of the rows 27 with the columns 28 could provide gaming squares 29, with each gaming square 29 representing a potential winning occurrence (e.g. score, outcome, and the like of a wagered upon sporting event) using the combined indicia 32 of the intersecting column 28 and row 27. The gambler 17 could then select one or more gaming squares 29 (e.g., one or more potential winning outcomes) for wagered upon sporting event (or some particular aspect or sub-event of the wagered upon sporting event[s].)

In at least one version, wherein the sports score (e.g., the score for the wagered upon sporting event) could be used as a potential winning occurrence for a wager and the sports score may be expressed in multiple digits numbers (e.g., basket ball score of 111 to 98), then for example the “one's” digits of the numbers of the sports score could be used to determine if a potential winning occurrence (e.g., a potential final sports score) is an actual winning occurrence. For example, a gaming square 29 having a intersecting indicia 32 of 1 and 8 could be the winning gaming square for such final score as 111-98 as well as the winning scores such as 21-18; 41-38; 51-38; and like. In this manner, the invention could be designed to allow a gaming square 29 to potentially represent several potential winning occurrences thus increasing the chances of winning and increasing the excitement of play for the gambler 17.

In at least one embodiment (e.g., the electronic form) of the wager form 10, the gambling squares 29 could display payout odds 42 of the wager format 10 for the possible winning score(s) represented by the gaming square 29.

In at least one embodiment, the invention could restrict multiple wagers to those gaming squares 29 which are contained in one or more invention operator-authorized geometric orientations (e.g. row, column, diagonal, adjunct gaming square, or other) in the grid 20.

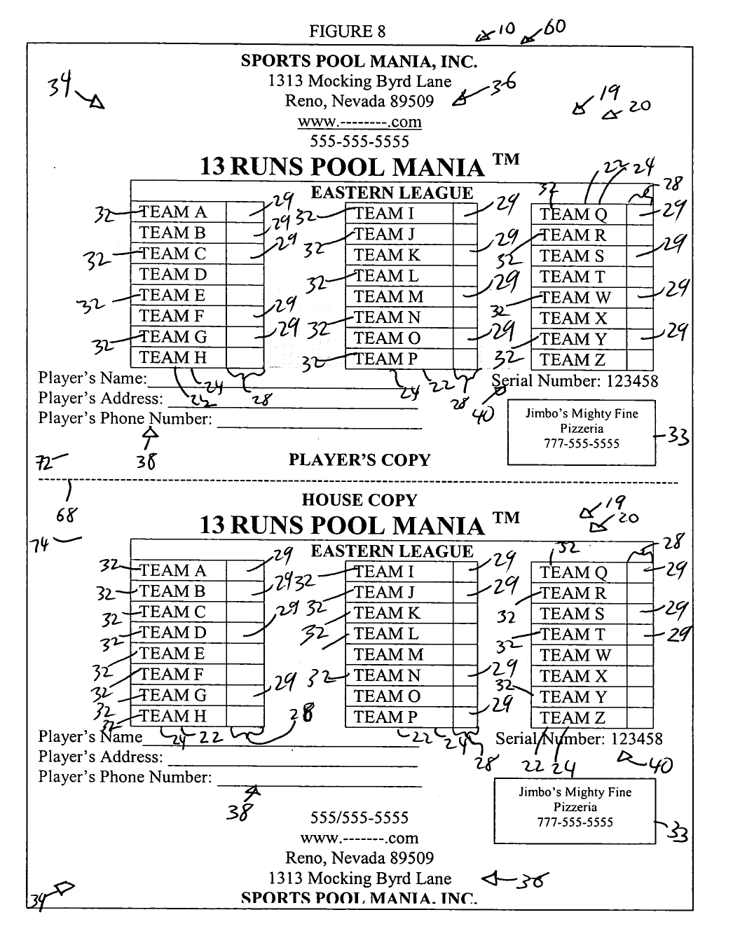

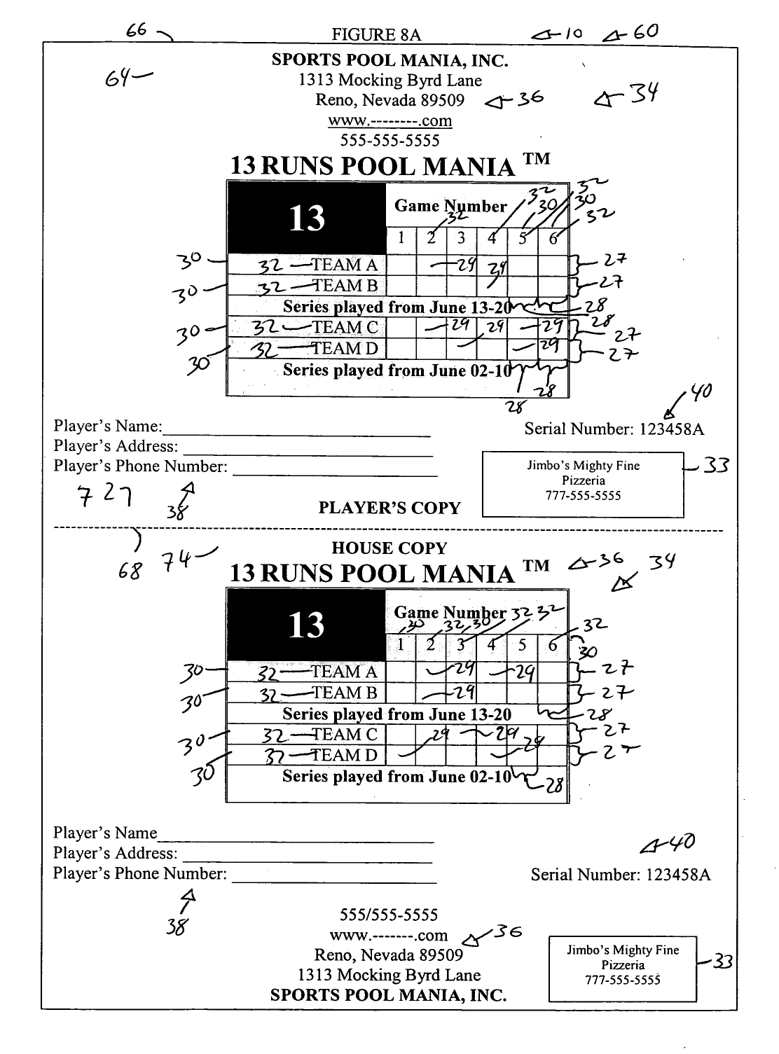

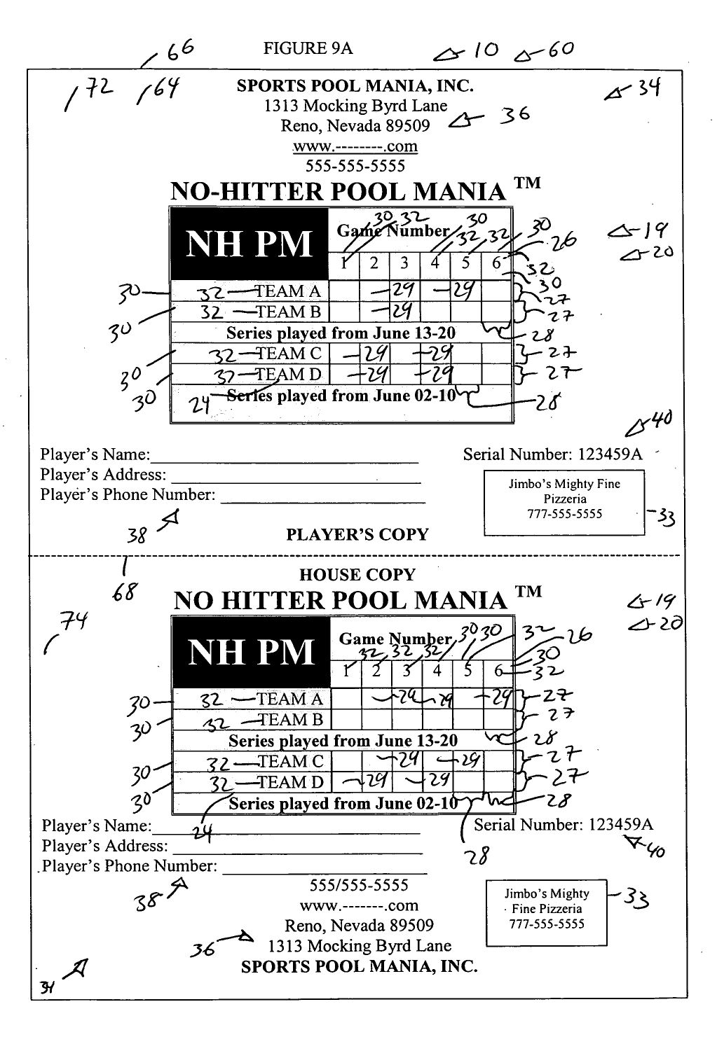

In at least one embodiment of the invention (substantially shown in FIGS. 8A and 9A), the wager format 10 could employ multiple or combined grids 20 per section to generally allow simultaneous multiple wagering for: a) simultaneous wagering on two or more wagered upon a sporting events (e.g., a baseball game and football game, a series of baseball games, two or more baseball series and the like), b) the wagering upon the occurrence of two or more different aspects of sporting event (e.g., a main bet on the final winning score and a side bet on a particular football player making a touchdown occurring at the end of a quarter; the half-game score, and the like.)

A second data field could be the playing communication means 34 with its data sub-fields of operator contact means 36, gambler identification means 38, and wager format identification means 40. The gambler 17 could use gambler identification means 38 (e.g., the paper wager card 60 having preprinted lines assigned to receive gambler's name, address, phone number, e-mail and the like) to record and transmit personal contact and identification information). In addition to the gambler identification means 38 being used to properly identify those gamblers who are the winning gamblers entitled to payout of winning wagers, the wager processing center 16 could form a database of its gambling clientele to identify gambling trends of such clientele as well as possibly further serving as a advertising database for the goods and services of invention operator 18 (as well as third party).

Operator contact means 36 could display indicia comprising of the invention operator's identification and contact information (e.g., invention operator's name, physical address, phone number, fax number, email, web site and the like.) This operator contact means 36 could allow the winning gambler 17 to establish later contact with the invention operator 18 after the happening of the actual winning occurrence for the collection of the gambler's winning wager(s).

The wager format identification means 40 could display indicia comprising of serial number (e.g., a bar code and other identifying designs), the serial number being substantially unique for a respective wager format 10 (e.g., if a thousand wager formats 10 are being issued for wagered upon event, then each wager format 10 could have its own unique serial number.)

The advertising means 33 could provide information that could include, but not be limited to advertisement of third parties or invention operator 18 and the like. The revenues generated by the advertising medium 33 could provide an additional income to the invention operator 18 to supplement the percentage taken from the common wager pool 16. The electronic form of the wager format 10 (not shown) could have a gaming square 29, when selected by the gambler 17, enabled an internet link that could allow the gambler 17 to access a web portal to obtain a wide variety of information regarding the wagered upon sport event or the potential winning outcome represented by that particular gaming square 29.

Wager Processing Center

The wager processing center 14, in at least one embodiment could be an operation that is fully run by the invention operator 18. The wager processing center 14 could be an institution, system or the like having the capability of receiving and handing wager information and wager funds; the ability to tabulate wager odds, managing a common wager pool 16 (which in some versions has sub-pools 43), and the capability of paying out winning wagers from the common wager pool 16 (e.g., sub-pools 43). In another embodiment (not shown), a separate financial institution (e.g., a bank), substantially independent of the wager processing center 14 but receiving and obeying instructions from the wager processing center 14, may provide the common wager pool 16 (e.g., as a banking or escrow account.) If a financial institution is used to hold and operate the common wager pool 16 (e.g. as an escrow account), then the interest generated by such funds held in the common wager pool 16 could be used as another revenue source or stream for the invention operator 18 outside of the above-described fixed percentage for payment of services rendered.

After the gambler 17 has utilized the wager format 10 (e.g., filled out the data entry fields on the paper wager card 60 and the like), the wager (e.g. wagered funds and the paper wager card 60) could be transferred (e.g., physically by agents of the inventor operator 18 or electronically) to the wager processing center 14. Upon receipt, the wager processing center 14 processes the accepted wagers by placing the wagered funds (e.g., wagered monies, wagered financial data such a credit card data, and the like.) into at least one common wager pool 16. The common wager pool 16 could be possibly be further compartmentalize in at least one embodiment to form one or more wager sub-pools 43 for holding any of the invention's side bets and the like for increasing the payout on the side bets.

Generally, once the commencement of the waged-upon event occurs, the wager processing center 14 may decline acceptance of any new wagers for that particular wagered-upon event(s); close the common wager pool 16; remove the fixed percentage from the common wager pool 16 (sub-pool 43); and tabulate (e.g. calculate) the final payout odds. The wager processing center 14 may use standard pari-mutuel protocols for calculating the final payout odds for winning the event by generally dividing the remaining pari-mutuel pool among all placed bets, and then generally rounding odds off to a gambling industry accepted/government specified denomination. The wager processing center 14 may issue the winning payout(s) in conjunction with actual winning event(s) information from the wagered upon sporting event and other factors to calculate the payout(s) for the winning wager(s).

Generally, the invention generally does not provide for the use of predetermined/preset odds (e.g., odds set by the invention operator 18 or others); the use of preset odds in combination with pool-based odds (e.g., pari-mutuel determined odds); or the seeding of the wager pool by the invention operator 18. However, it is envisioned that at least one embodiment of the invention could use one or more such elements.

The payment or payout of any such winning wager(s) may be accomplished by generally transferring calculated winning payouts, credits and the like from the common wager pool 16 (e.g., sub-pools 43) directly to the gambler 17 or indirectly to the gambler 17 by depositing such funds with an account designated by the gambler for receiving the gambler's winnings. Along with this transference could be the communication of information regarding the winning wager(s) to gambler 17 as well. In at least one embodiment, the gambler 17 could present the first section 72 (player's copy) of the paper wager card 60 to the invention operator or agent thereof to receive any winning payout of any wagers won by the gambler 17. The invention operator could use the data of the wager format identification means 40 (e.g., serial number) from the presented first section 72 and match it with data of the wager format identification means 40 of originally submitted second section 74. Additionally, the invention operator 18 may also compare data of identification presented by the gambler 17 with data from the gambler identification means 38 on the originally submitted second section 74 to properly match up any winning wager with its respective winning gambler 17.

Generally, the fewer winning wagers or bets in relation to the entire common wager pool 16 for the particular wagered upon event, the greater the individual payoff to the winner(s). Conversely, if many gamblers 17 have bet on the actual winner occurrence of a sport contest or game then the payoff may be low, simply because of many winners who will divide the winnings from the common wager pool 16.

In at least one embodiment of the invention, the wagered amounts, instead of being money or credit (wagering on money or credit may be prohibited in many jurisdictions), could use a point reward system. In such a system, the gambler 17 generally obtains from the invention operator 18 points or tickets (for which prizes or rewards could be generally immediately redeemed) to wager. In one version of this embodiment, the invention operator 18 issues out tickets or points free of charge for promotion purposes. Here for example, where the invention operator 18 may also be an operating a dram shop (e.g., alcoholic bar) the invention operator 18 may use the invention primarily as a means to advertise and promote for the attraction of patronage to a desired venue (e.g., the bar). Here, invention operator 18 may give away tickets free of charge to bar patrons and potential bar patrons who then engage in participation of the invention at the bar. As the patrons (actual and potential) engage in the invention at the desired location (e.g., the bar) and win more tickets which may be used to redeem prizes (or make more wagers). As the patrons enjoying the invention, they could buy drink and food at the bar and in this manner generally offset the operation costs of the invention's operation. In another version of this embodiment, the tickets or points could be printed in on advertisement, coupons or other attendance incentives handed out by the invention operator to entice the public to the desired venue.

Various Embodiments of the Invention

As generally shown in FIG. 1A, one embodiment of the present invention, (e.g., American Football Pool Mania) could use a wager format 10 to place wagers on sports game(s). The wager entry means 19 whose grid 20 could have an x-axis 24 assigned to score of one game team (e.g., a home team-Chicago Bears professional football team) while the y-axis 26 is assigned to the score of another game team (e.g., an away team-Green Bay Packers professional football team). Generally, only the “one's” digit of the game score could be used to denote a winning score (the “tens” and numerically higher digits for the determining game score could be ignored for winning occurrence tabulation).

In at least one version of the present embodiment, the final winning score for sports game 20 of the wagered upon sporting event could be used the actual winning occurrence for the wager. In another embodiment, separate sub-event(s) could be wagered upon as well (e.g., the final score for a quarter of American football game could be the actual winning occurrence for side bet.) Accordingly, specific sub-pools 43 of the common wager pool 16 could be established for each of those sub-event wagers or side bets for the collection and payout of the sub-event wagers. Otherwise a specific amount (e.g., a fixed percentage) of the common wager pool 16 could be used for the payout of sub-event wagers or side bets. Although, extended play (e.g., “overtime”) could occur in various wagered upon sports event (e.g. an American football game) this occurrence generally has no bearing on the sub-event wagers placed in the first three wagered upon quarters. The extended play could have a possible effect on the final game score (and any placed wagers for that score) for the fourth or final quarter of the wagered upon sporting event and should be taken into account by the invention operator 18 (substantially shown in FIG. 1) when setting the rules and regulations of the play (e.g., overtime play resulting in additional time periods or quarters and the final time period score is the final winning score.)

In this manner, as with many embodiments of the invention (utilizing side bets, “digits” winning score determination, and the like), a wager (e.g. a wager placed on the gaming square 29 representing a winning score of 6-1 in favor of the away team) could have several opportunities to win. In the example of an American football game, the selected score (e.g. 6-1) could be applied to each of the final scores for each of the first three quarters as well as the final over all winning score. Further, if any of actual winning score (6-11, 16-1, 16-11, 26-1; etc) for any of the quarters have matching “ones” digits that could provide the actual winning occurrence for the determination of the winning wager. This could provide for an increased number of winning situations, thus increasing the excitement of play with a potential resultant increase of gambler participation in invention.

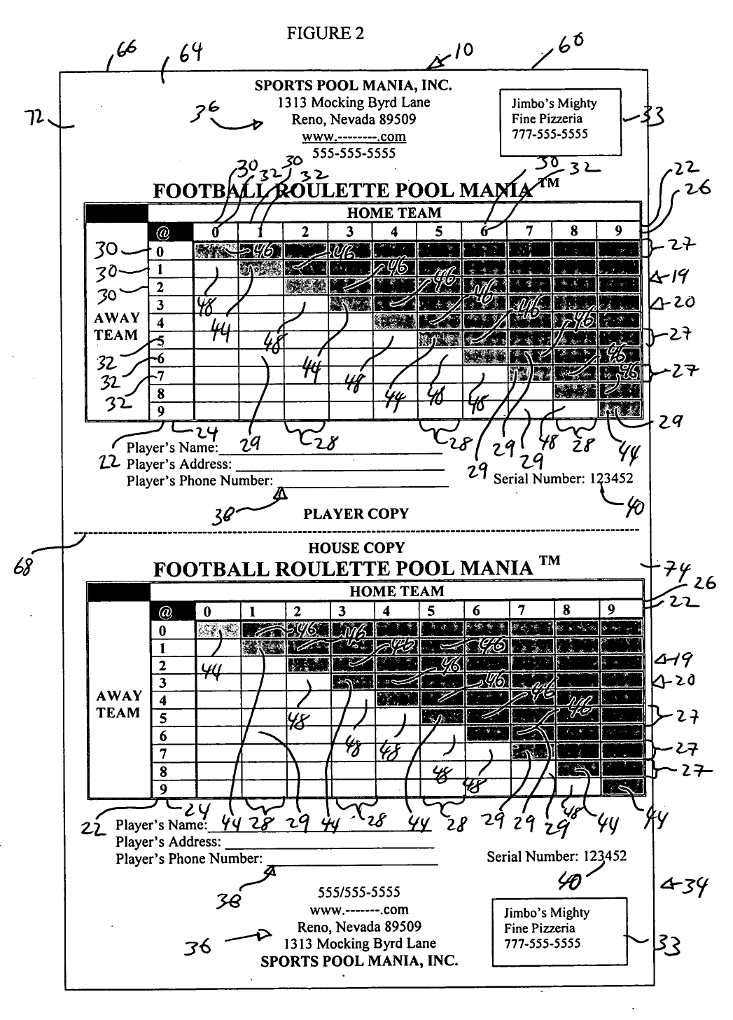

As generally shown in FIG. 2, another version of the embodiment (e.g., Roulette Pool Mania) the wager format 10 could have a wager entry means 19 whose two axis grid 20 with the x-axis 24 and y-axis 16 generally assigned to two respective separate sports entities (e.g., teams, players, and the like) competing in the wagered upon sporting event (e.g., American football game). The gaming squares 29 so created by the grid 20 may be colorized, shaded or otherwise differentiated to facilitate the identification to allow certain combinations of gaming squares that may have certain wagering properties. For instance, the center diagonal gaming squares 44, which generally represent tied scores between the teams, may be assigned a first color or shade. The above-gaming squares 46, located above the center diagonal gaming squares 44, may be a second color or shade, while the below-gaming squares 48, located below the center diagonal gaming square 44, may be a third color. The visual differentiation of the set of gaming squares could denote that a set of gaming squares 29, which could receive a special bonus payout on top of the ordinary payout if a selected gaming square 29 within that set which represented an actual winning occurrence.

If pre-set odds are used in this present embodiment, the center diagonal gaming squares 44 and the below-gaming squares 48 could be assigned to pay out winning wagers at 2:1 odds while the above-gaming squares 46 could be assigned payout based on 1:1 odds. Other versions of this pre-set odds version could use additional different colored gaming squares 29, which could be used to denote other payout odds such as pay 2:1 wager multiples.

As generally shown in FIG. 3, this embodiment (e.g., Touching Squares Pool Mania) may have a wager format 10 whose wager entry means 19 features a standard grid 20 as discussed above, but generally provides secondary payouts for selected gaming square(s) 29 that do not represent an actual winning occurrence for the wagered upon sporting event. If the selected gaming square turns out to be a winning gaming square 52, then the invention provides for the payout of that wager. In addition, if a selected gaming square 29 is not the winning gaming square 52 but is located adjacent (e.g., located at top, bottom, side of or diagonal to the winning gaming square 52) then these touching gaming squares 29 (shown in different shade only for ease of identification for this example) to the winning square(s) 52, then that selected adjacent gaming square 50 may have a bonus payout. In one version of the embodiment, this bonus payout could be paid from the sub-pool 43 which holds a fixed percent of the common wager pool 16 funds. Another embodiment could treating the adjacent gaming squares wagers as being side bets and placing the collection of side bets wagered funds into the sub-pool 43 assigned to those side bets.

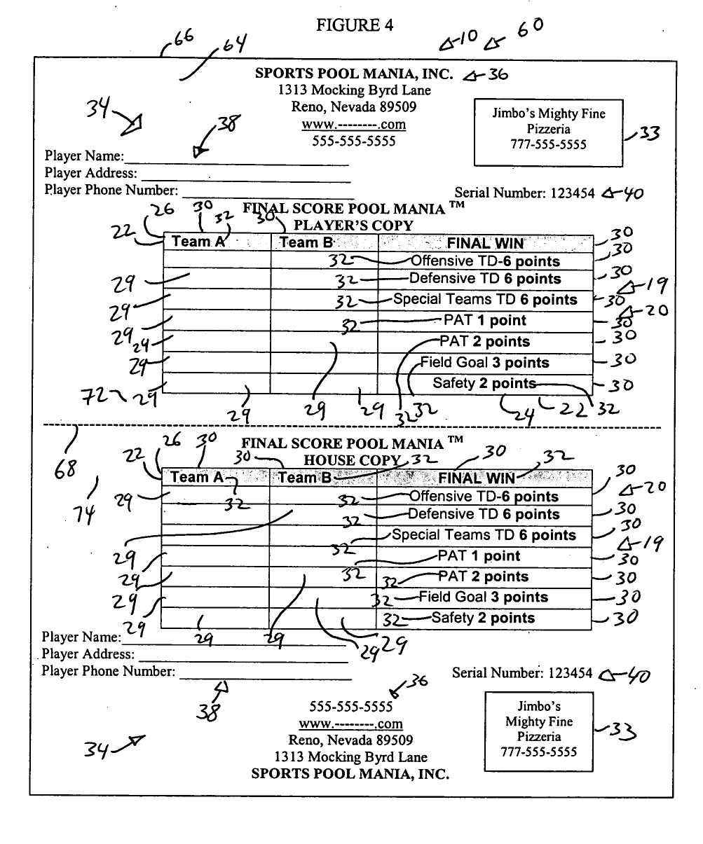

As generally shown in FIG. 4, another embodiment (e.g., Final Scoring Pool Mania) may allow the wagering upon the various possible occurrences that could happen within a wagered upon sporting event. The wager format 10 for this embodiment may have a wager entry means 19 that uses a simplified x-y grid 20 that may comprise of at least horizontal x-axis columns 25 whose indicia 32 of is assigned to each team/player playing in a wagered upon event(s) as well as the sub-event category (e.g., entitled “Final Win”). The y-axis row 27 accordingly could have its indicia 30 various potential sporting sub-events (that could result in a final winning score for the wagered upon sporting event.) For example, such potential sporting sub-events resulting in a final winning score for an American football game could include, but not be limited to: Offensive Touchdown—6 points, Defensive Touchdown—6 points; Special Teams Touchdown—6 points; Field Goal 3-points. These potential sub-events resulting in a final (e.g., winning) score could also include generally non-point creating sub-events (e.g., in American football, these sub-events could be fumble, interception, foul play, etc). The wagers could further include betting on a sub-event of a particular player making a winning play (e.g. Joe Jones making a touchdown 6-points and the like.) Although this particular example is shown for football, the embodiment could accommodate the wagering on other sports as well.

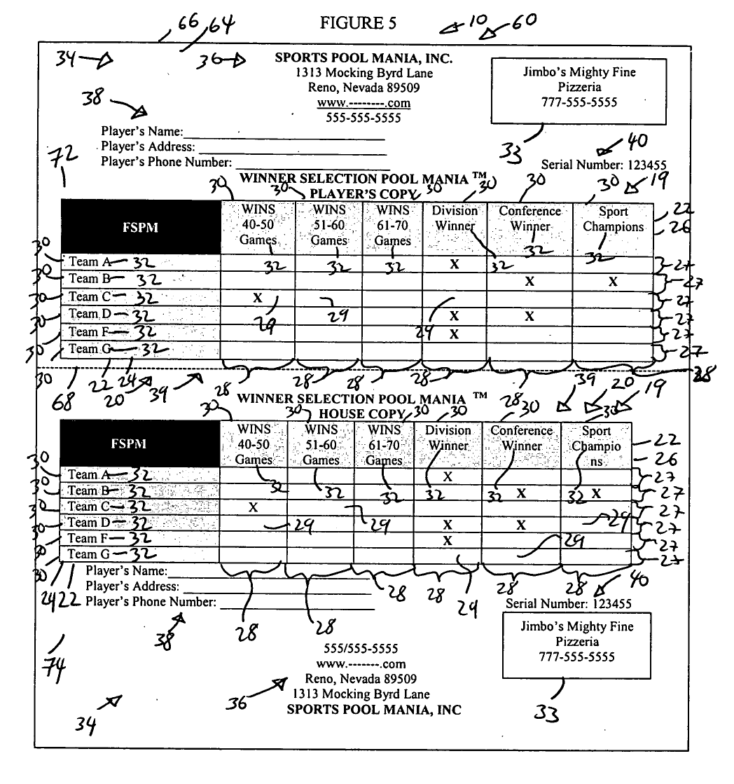

As generally shown in FIG. 5, another embodiment (e.g., the Winner Selection Pool Mania) could provide wagering on the outcomes of progressive sub-championship events (e.g. those which determine a division championship) that could lead up to an overall championship within a particular sport (e.g., within professional American baseball these sub-events could be the playoffs, divisional championships, league championships and World Series). This embodiment could provide with the wagering being open and closed weekly (or more frequently as particular wagered on the event could require) on events leading up to the final championship play.

The wager format 10 of this embodiment could utilize a grid 20 whereby the indicia 32 of the x-axis 24 could be assigned to different teams (or players) that are potentially eligible to compete in the championship or other major sporting event. The indicia 32 of the y-axis 24 could be assigned to the various progressive sub-championship events at which the teams (e.g., players) generally have to succeed in order for them to generally compete at or play in the championship event(s). These progressive championship sub-events could include (e.g., such as for American baseball) winning 40-50 games; winning 51-60 games; winning 61-70 games; winning the division, winning the conference, winning the league and the like. The last event wagered upon could also be the winning of the championship itself. The X's in the gaming squares 29 could represent the gambler's marking of selected gaming squares 29. As with other embodiments of the invention the wagers for the championship sub-events could be collected into and paid out of respective sub-pool 43 or be a fixed percentage assigned from the common wager pool 16.

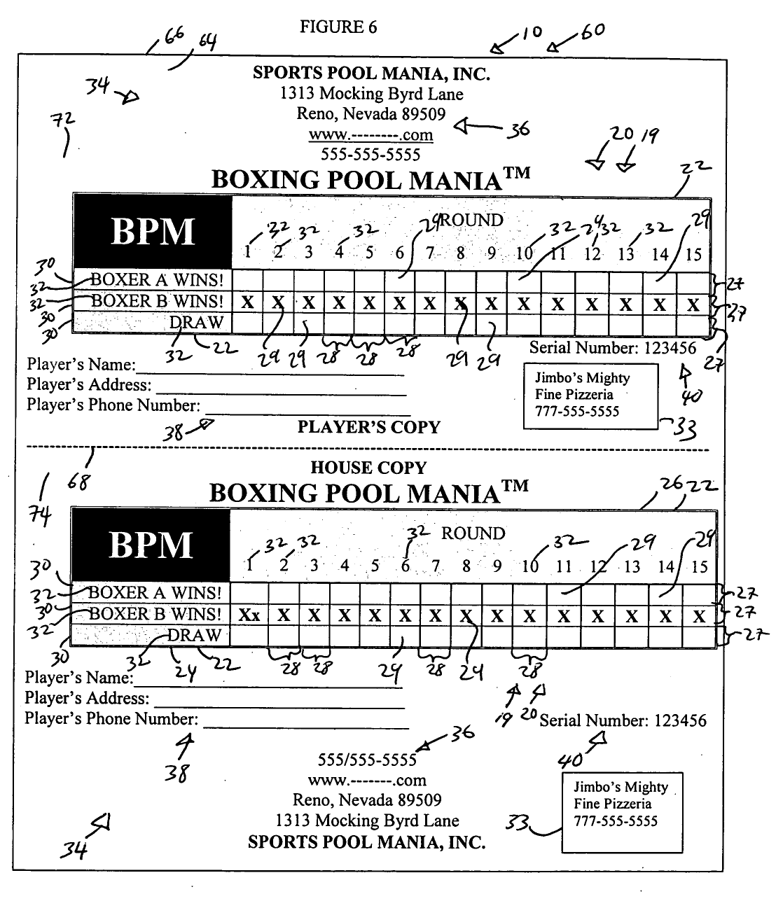

As generally shown in FIG. 6, another embodiment (e.g., Boxing Pool Mania) of the invention provides for a wagering upon a sport (e.g., boxing, tennis) which is played in a plurality of sets or rounds, wherein the rounds (based upon a team's or players performance) may be won, lost or tied (e.g., draw.) The number of rounds won by the player or team decides the winner (or tie) for the wagered upon sporting event. The player or team having the most numbers of winning rounds wins the sporting event. The wager format 10 for this embodiment could have a wager entry means 19, which may have a grid 20 wherein indicia 32 of the x-axis 24 (e.g., rows 27) may each be assigned to the winning of the sub-event by a particular player (or team) or the occurrence of a draw or tie between the players (or the teams). For example, one row 27 could represent a first player winning a round of the wagered upon sport, a second row 27 could represent a second player winning a round of the wagered upon sport, and a third row 27 could represent a tie between the first and the second players (or teams). The indicia 32 of the y-axis of the grid 20 (e.g., columns 28) may be assigned to various numbered rounds of the wagered upon event (e.g. boxing fight or tennis match). The wager then could be placed upon one or more rounds based upon the possibility that a specific player (e.g., team) wins that round or a possible tie occurring in that round.

In addition to selecting various spot wagering, the wager could be geometrically based. The wager could be “row” wagering wherein gambling squares 29 located in a row could be selected (shown here by the placement of an “X” an entire row.) Here, the wager could encompass the possibility that a specific player could win (or that tie could occur in) all the rounds (or at least one round) in the wagered upon sporting event. Row wagering could allow gambling that player A may win all the rounds, player B may win all the rounds, tie will occur for all the rounds, and variations thereof. Similarly, a wager could be “column” wagering to generally guarantee a winning bet for that wagered upon round (e.g., the wager covers the possibility of the occurrence for fighter A [e.g. fighter one] to win in Round 1, fighter B [fighter two] to win in Round 1, and draw in Round 1, etc.) However, the wagered upon boxing fight still could be cut short by a knockout in an earlier rounds (generally this premature ending does not happen in round events like tennis unless a player is ejected for example). In such an instance, all wages (including “row” wagers) placed on later rounds could be treated as wager losses.

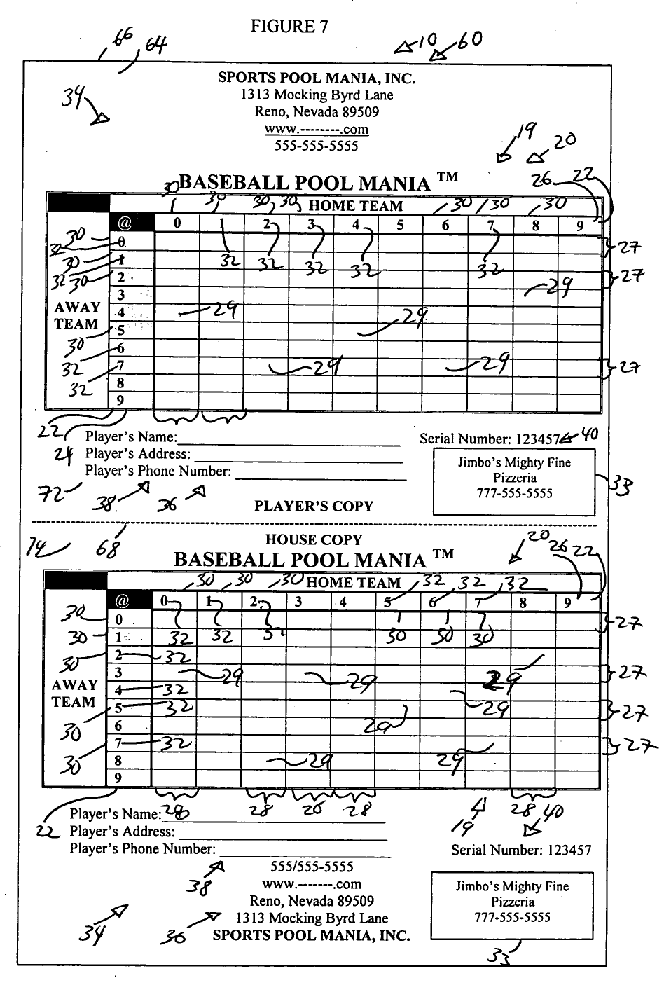

As generally shown in FIG. 7, another embodiment (e.g. Baseball Pool Mania) of the invention is similar to the Football Pool Mania embodiment in that the wager format 10 may utilize the grid 20, wherein the each axis 22 may be assigned to a team of particular wagered-upon sporting event. Each axis 22 may be broken down into segments 29, whose indicia 32 may be used to respectively denote one team's last digit for final score. Final score wagers may be denoted selecting gambling squares 29 on a spot wagering basis (e.g., individually selecting gaming squares 29 generally unrelated to one another in a geometric orientation such as a row, column, and the like). In addition, row, column, adjacent square and other geometrically based wagering may be employed in addition to or instead of spot wagers.

Alternative versions of the present embodiment could include side wagers or bets on sub-events placed alongside the main wager (for the final score). The side bets could include wagers placed on the scores for the various innings of play. The placement of the side bet(s) could utilize marking the selected gambling squares 29 for side bet in a manner different from final score wager gambling square(s) 29. The selected side wager gambling square 29 could be marked, for example with “1^{st}” to denote a “First Inning” score wager. The electronic versions of this embodiment could allow markings to be selected and displayed relative to the selected gambling square 29 to indicate a main wager or the various types of side bets.

As generally shown in FIGS. 8 and 8A, another embodiment (e.g. 13-Run Pool Mania) of the invention wagers upon an exactly 13 numbered potential winning occurrence to happen in a game. In baseball for example, this 13 numbered potential winning occurrence could be exactly 13 home runs, 13 hits, 13 runs, 13 points, 13 strikeouts, 13 stolen bases, 13 walks, or the like. If the wagered upon team (or player) during the game or contest exceeds the 13 numbered potential winning occurrence (e.g. a teams gets 14 hits, 15 runs, 23 points and the like) then the 13 number potential winning occurrence does not happen or is otherwise nullified. To win the wager, the wagered upon team (or player) needs to both win the game (or contest) and have the exact 13 numbered potential winning occurrence happen.

This embodiment could generally use a wager format 10 whose wager entry means 19 has a modified grid 20 having an x-axis column's indicia 32 provides for a listing various teams (e.g., the listing of team could be a sub-field of a sport such as a league [e.g., American League or National League] of American Baseball.) The y-axis's indicia 32 are generally not used in this embodiment. The column 28 next to the x-axis 24 could contain the gambling squares 29 for the wagering. If a winning event occurs, it can be addressed by using the above-discussed pari-mutuel standards for wager payouts. If more than one winning event occurs (two or more teams have a 13 numbered potential winning occurrence and win their respective games, the common wager pool could be split accordingly. Alternatively, if no one wins during an immediate game or series that is wagered upon, the embodiment may provide for the rolling over of the common wager pool 16 into the next common wager pool 16 for the next wagering of this embodiment for same wagered upon sport.

As generally shown in FIG. 8A, another version of 13-Run Pool Mania embodiment could be the series version of the 13 Run Pool Mania embodiment. This version could be employed for wagering in a sport (such as American baseball) wherein two teams may play a tournament or a series of games (e.g., non championship games such as a subway series between the Chicago Cubs and the Chicago White Sox) within a fixed period of time (e.g., a week or so). This version can also apply to a set of series (Chicago Cubs-Chicago White Sox series and a New York Yankees-Boston Red Sox Series.)

The wager entry means 19 of the wager format 10 for this version may employ one grid 20 with at least two x-axis columns 24, each column 24 could be assigned to one sports team playing in the series. The indicia 32 of the y-axis rows 27 could be assigned numeration to generally denote the number (e.g., first, second, third) of a particular game within the series being wagered upon. The grid 20 could be further configured to handle multiple series between the two teams (e.g. a series between two teams early in the baseball season and a series played by the same teams later in the season; one series played between two teams and another series played by another set of teams.)

As above, the winning the series version of the 13 Run Pool Mania wager generally requires at least two things need to happen: 1) the 13 numbered potential winning occurrence (e.g., the team has exactly 13 hits) happens to the selected or wagered upon team; and 2) the selected or wagered upon team then needs to win the game in which the 13 numbered potential winning occurrence occurred for them. If the 13 numbered potential winning occurrence (e.g. the actual winning occurrence) happens, it can be addressed by using the above discussed pari-mutuel standards for wager payouts. Alternatively, if no one wins during an immediate game or series that is wagered upon, the embodiment may provide for the rolling over of the common wager pool 16 into the next common wager pool 16 for the next wagering of this embodiment for the same wagered upon sport (e.g., a different series played between the Boston Red Sox and the Toronto Blue Jays). Alternatively, these wagers may be considered only as side bets and are considered generally to be a part of (e.g., a percentage of) the common wager pool 16. The various versions of 13-Run Mania Pool embodiment could possibly allow for both column and row (geometric) wagering in addition to spot wagering.

As generally shown in FIGS. 9, 9A, another embodiment (e.g., No-Hitter Baseball Pool Mania) may follow the general setup and protocols of the 13-Run embodiments shown in FIGS. 8 and 8A. In this embodiment, instead of wagering upon the potential happening of a 13 numbered potential winning occurrence, potential winning occurrence is a “No Hit” or “No-Hitter” baseball game. In such a game, one team prevents the other from getting an official hit during the entire length of the game, which must be at least 9 innings by the current Major League Baseball definition. Foul balls, foul tips, ground outs, fly outs, walks and errors generally do not prevent the occurrence (e.g. break up) a “No-Hitter” game. It is generally implied by the use of the term “No-Hitter” that the team having a “No-Hitter” has won that particular game.

As substantially shown in 9A is the series version of the No-Hitter Pool Mania embodiment that generally follows the general format and protocols of the series version of the 13 Run Pool Mania embodiment except that potential winning occurrence for the wager refers to at least one of baseball teams winning a “No-Hitter” game during the series.

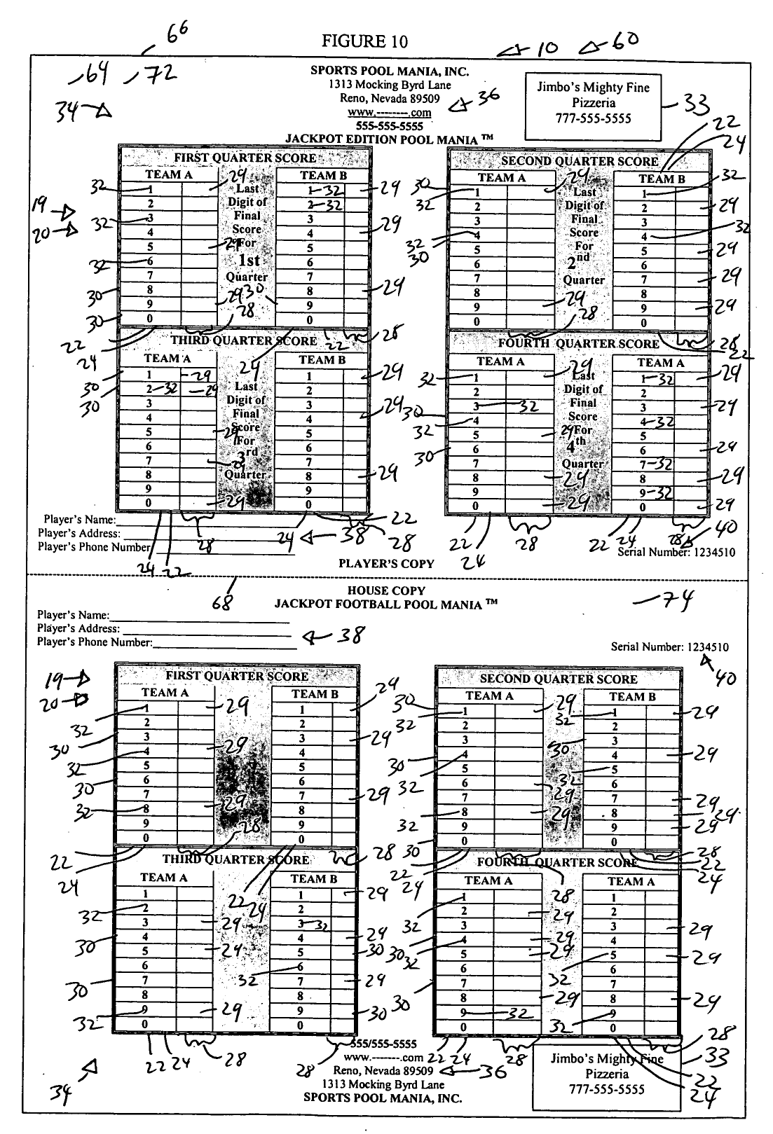

As generally shown in FIG. 10, another embodiment (e.g., the Jackpot Edition Pool Mania) allows for wagering upon those sports whose length of play may be determined by periods of time (quarters and the like for American football; basketball, hockey, etc.) rather than the occurrence of a wagered upon winning event. The present embodiment could have wagering on certain scores occurring at certain times during a game. The winning wager could need to have the correct scores for each of the wagered upon the time periods. Because there could be very high numbers of potential winning combinations for this wager (e.g., generally about 100,000,000 potential winning combinations for a football game with betting on all four quarter scores-thereby generally generating greater odds than a state lottery) there may be a significant potential for no payouts on a particular wagered upon sporting event. To accommodate for this possibility, the embodiment may provide for a progressive jackpot wagering (e.g. a rollover of the un-won wagered funds from one common wager pool 16 to the next common wager pool 16) rather than focusing on pari-mutuel wagering (where generally there is at least one winning wager and payout for each wagered upon sporting event).

The present embodiment could utilize a wager format 10 having a plurality of grids 20, with each grid 20 representing a time period of play in which two teams (e.g., players) playing against one another (e.g. four grids 20 for each timed period of play [e.g., a quarter] for an American Football game). The grid 20 for each time period (e.g., quarter) could have two sets of x-axis 24 and an associated column 28 providing the gambling spaces 29 for the wager(s) placed in that quarter. Each x-axis 24 could have indicia 32 bearing numeration of 0 through 9 (e.g., representing the last or “ones” digits for one half of a possible score for the quarter). Each column 28 for the grid 20 could be assigned to each of the teams (players) playing in that particular time period (e.g., quarter) for the wagered upon event.

If there is a winning wager(s) for the wagered upon event, the payouts could be made according to pari-mutuel standards. If there is no winning wagers (e.g., no correct selection of sequenced winning quarterly scores for a particular American Foot game), then the wagered funds (e.g., jackpot) for that game could progressively rollover to the common wager pool 16 for the next selected game or selected game in a series. In this manner there would be an eventual win with a potentially large payout.

The governmental authority covering the jurisdiction in which the invention may be practiced may require the wager to be paid out and not rolled over at the conclusion of the wagered upon game(s). One solution could be the treatment of the wager in this embodiment as side bet with the side bet funds being a part (a fixed percentage payout) of the common wager pool 16.

Another solution could ensure a winning wager for the wagered upon sporting event by determining a selected gambling square 29 to be the winning gambling square 29 (e.g., entitled to the winning payout) through a series of elimination steps. In elimination step one, if no one wins in the picked game or series, then this embodiment's wagering protocol could provide for the splitting of the wager pool among the winners of the correctly picked third quarter score of the wagered-upon event. If no such winner(s) exist, then the second elimination step could provide that the payouts are made to the winner(s) of correctly picked second quarter scores of the wagered-upon event. If no second quarter winners, then the third elimination step could provide for winning payouts to the winner(s) of the correctly picked first quarter scores of the wagered-upon event. If no first quarter winners, then the fourth elimination step could be the selection of winners based on those who had picked the gambling square(s) 29 whose represented scores are the closest to the actual first quarter scores. Because the above alternate selection protocols generally go into effect after the conclusion of the wagered upon sporting event, the protocol(s) could potentially increase participant's interest in and enjoyment of the post-sporting event wagering action.

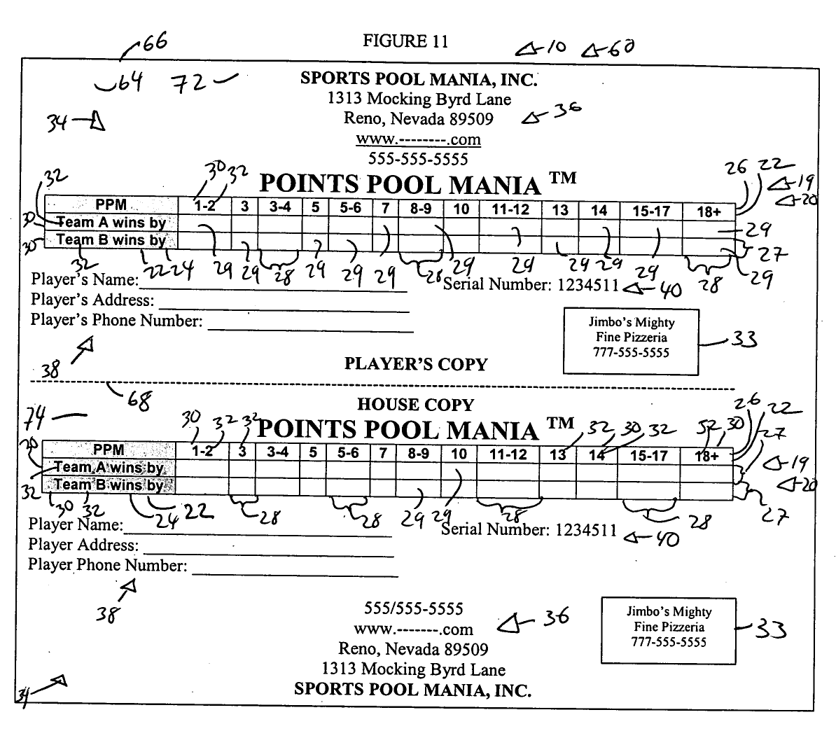

As generally shown in FIG. 11, another embodiment (Points Edition Pool Mania) of the invention could provide wagering on points or point spread in a final score for a wagered upon contest or game. In this embodiment, the wager format 10 could utilize a wager entry means 19, which generally has at least one grid 20 wherein the indicia 32 of x-axis rows 27 is assigned to the identification of the two teams playing in the wagered upon game, while the indicia 32 of y-axis columns 28 may be assigned to offered point(s) or point spread(s) (e.g., that the selected team will win over the other team by 1-2; 3; 4-5; 7; 8-9; 10; 11-13; 15-17; 18-21; 22 or more points) by which a team (e.g., a player) may win over the opposing team (e.g., opposing player) in a selected wagered upon sporting event(s). This wager format 10 generally allows the wagering on a prospective winning team or player (“quick bets” or “row” betting) as well as wagering on the number of winning score points by which the prospective winning team or player will beat the opposing team/player.

The Process

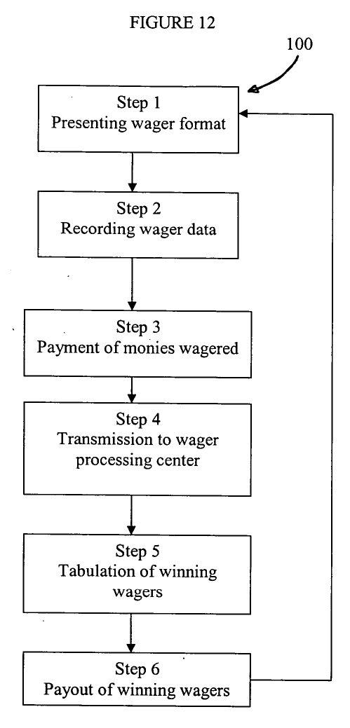

As substantially shown in FIGS. 1 and 12, the process 100 of operating the invention could start with step 1, presenting the wager format 10. Here the invention operator 18 or duly authorized agents thereof could transmit or present (or cause the transmission or presentation of) the wager format 10 to the gambler 17. In this step, the wager format 10 could be in a paper form (e.g., paper wager card 60) or an electronic embodiment (not shown) in the form of electronic media connected to a wager processing center 14 wherein the electronic media may generally present to the gambler a graphic interface substantially showing a visual image of the wager card 10. Once step 1 is substantially completed, the process 100 could generally proceed to step 2, recording wager data.

At step 2, recording the wager data, could have the gambler 17 using the wager format to enter gambler identification information (e.g., filling in the gambler's name, address, telephone number and the like on the lines provided by the gambler identification means 38.)

The gambler 17 then could decide on what wager(s) (if any) to make. This decision could include, but not necessarily be limited to such issues as the selection of one or more gaming squares 29 (as well as any above gaming squares 46, below gaming squares 48, center diagonal gaming squares 44, adjacent gaming squares 50, and the like as discussed above) as possible winning gaming squares 52; what monies to be paced on which selected gaming square(s) 29; and the like; point spread analysis (e.g., Points Edition Pool Mania embodiment); and the like. Once the gambler 17 had made the above wagering decisions, the data or information of the wager could be recorded on the wager entry means 19 (for the paper by appropriately marking the selected gaming squares 29 and the like). For the perforated version of the paper wager card 60, the gambler 17 could place duplicate wager information or date on the both sections (first section 72, second section 74) of paper wager card 60. (In the electronic format, this step could include entering wager data via computer user interface [e.g., a touchpad, keypad and the like) into the electronic version of the wager format 10.) The gambler 17 could then receive various data from wager format 10 such as wager format identification means 40, operator contact information 40, advertising medium 33 and the like. Once step 2, recording of wager data, is generally completed, the process 100 could substantially proceed onto step 3, payment of monies wagered.

In step 3, payment of monies wagered, the paper form of the invention could have the gambler 17 transmit the completed paper wager card 60 along with the wagered monies to the agents of the invention operator 18 for further transmission to the wager processing center 14. The perforated version of the paper wager card 60 could allow the invention operator 18, upon receipt of the paper wager card 60, to separate the paper wager card 60 into sections (first section 72—player's copy, second section 74—house copy) along the perforation 68. The first section 72 (e.g., player's copy) could be returned back to the gambler 17 as a receipt for the placed wager. In alternative embodiments, the gambler 17 could pay the wagered monies by credit card, debit card, or other suitable money or rewards medium. In the electronic embodiment, the gambler 17 through the wager format 10 could enter payment data (e.g., credit card information and the like against which the wager could be charged, deducted or debited from. Once step 3 is generally completed, the process 100 may substantially proceed onto step 4, transmission to the wager processing center 14.

At step 4, transmission to the wager processing center 14, the wager monies and wager data may be transferred to the wager processing center 14. This may occur by physically transmitting the paper wager card 69 to the wager processing center 14. The wager processing center 14 can take the wager data from the paper wager card 60 (entered along with other wager data from other placed wagers for that particular wagered upon sporting event) into an appropriate data processing system of wager processing center 14 for the processing of the incoming wagers and the payment of winning wagers. This system may use tabulators and the like to project the odds of winning occurrence having within the wagered upon sporting event and calculate the winning payoffs for the won bets (the projected odds could be relayed back to the gambler by news broadcast or by the electronic form of the waged format 10.) The wager monies could also be transmitted to a common wager pool 16 (e.g., sub-pools 43) that may be operated under the control of wager processing center 14. In the electronic version, the wager data (including the particulars of the wager and source of funds against which the wager is to be charged) could be transmitted electronically from the computer user interface (e.g., wager format 10) to the appropriate data process system (not shown) which could include a central processing unit or computer network running an appropriate accounting and tabulation software system. The data process system could sequester the paid in wager funds for a particular wagered upon event into a common wager pool 16 created for that particular wagered upon event. The data processing system then could remove the amount (e.g. fixed percentage) used to pay the invention operator 18 for running the invention, governmental fees, taxes and the like. After substantially step 4, the process 100 could generally proceed to step 5, tabulation of winning wagers.

In step 5, tabulation of the winning wagers, the news of the occurrence of the wagered upon sporting event (e.g., actual winning occurrence) could be received by the wager processing center (e.g., via mass media) and the actual winning occurrence information may be entered into the accounting system to determining who the winners are and how much (e.g., using the payout odds calculations) they will get paid from the remaining amount of the common wager pool. The winning payouts (winning wagers) may be based on the size of the common wager pool, the number of wagers placed upon the winning event, winning payout ratios, the size of the individual winning wagers, and the like. After step 5 is substantially accomplished, the process 100 could generally proceed to step 6, payout of winning wagers.

In step 6, payout of winning wagers, the identified winning gambler are paid winning wagers, which are paid out of the common wager pool 16 (e.g., sub-pool[s] 43). In the paper format of the invention, funds can be transmitted from the common wager pool 17 to the invention operator 18 (or agents thereof) that then transmits them to the identified proper winning gambler 17. In the electronic format of the invention, the wager processing center 17 can transmit the amount of the winnings from the common wager pool 14 (e.g., sub-pool[s] 43) to the source of the gambler's funds or make payment directly to the gambler 17 via a cash dispenser (not shown) controlled by or otherwise connected the wager processing center 16. At the substantial completion of step 6, the process could be terminated or it could return back to step 1,

Payout (and odds) for invention could be calculated by the standard pari-mutuel calculations, with an ability to increase the payouts for those winning wagers involving “long shot” point spreads. This is seen as being generally as an improvement over the traditional point spread wagering, in that this pari-mutuel format generally provides for significantly larger payout.

In addition to the pure pari-mutuel form of the invention, it may be envisioned that the invention could encompass a format or process whereby the invention operator 17 could provide initial seeding of the common wager pool 16 (e.g., sub-pool[s] 43) to generally help provide a methodology of establishing the initial odds for the wagered upon sporting event.

The various embodiments of the invention could be applied to a wide variety of sports including, but not limited to, dog racing, horse racing, jai alai, football, diving, lacrosse, field hockey, track and field, marathon running, Iron man contests, swimming, martial arts, wrestling, basketball, hockey, soccer, running, rugby, tennis, weight and power lifting, automotive racing, motorcycle racing, bicycle racing, Olympic sports. The geometric wagering protocols (single/spot, column, diagonal, touch square wagering, etc.) can be applied to the various wagered-upon events as well.

As discussed in greater detail above the various embodiments of the invention may provide for a pari-mutuel form of sports square style of wagering which may rely upon a common wager pool for handling collection and payout of wagers allowing the invention to be more acceptable to various governmental entities that may not otherwise permit gambling within their jurisdictions. The invention may also provide for increased gambler interest and participation by also substantially allowing wagering upon various non-final or non-ultimate outcome sub-events (e.g., a performance of a certain player during a certain portion of the game) of a sporting event that was generally not previously provided for by sports square gambling.

While these descriptions directly describe the above embodiments, it is understood that those skilled in the art may conceive modifications and/or variations to the specific embodiments shown and described herein. Any such modifications or variations that fall within the purview of this description are intended to be included therein as well. It is understood that the description herein is intended to be illustrative only and is not intended to be limitative.

We claim as our invention:

1. A process for sports square wagering comprising:
a. presenting a grid comprised of a plurality of gaming squares, the gaming square representing a potential winning occurrence for a wagered upon sporting event;
b. selecting at least one gaming square;
c. transmitting wagered funds to a common wager pool based upon the at least one selected gaming square;
d. determining that one or more selected gaming squares represents an actual winning occurrence;
e. calculating a payout for at least one actual winning occurrence gaming square, the payout being based on at least the size of the common wage pool and the total number of winning wagers; and
f. issuing the calculated payouts from the common wager pool as the winning wagers.

2. A process of claim 1 wherein selecting at least one gaming square is accomplished by selecting gaming squares located within a geometric orientation.

3. A process of claim 2 wherein the geometric orientation could be a geometric orientation selected from a group of geometric orientations consisting of: a column, a diagonal; a row; adjacent gaming squares.

4. A process of claim 1 wherein a fixed percentage of the common wager pool is used to provide for the payout of one or more winning side bets.

5. A process of claim 1 wherein the wagered funds for one or more side bets are placed into a sub-pool of a common wager pool.

6. A process of claim 5 wherein winning side bets are paid from a sub-pool of the common wager pool.

7. A process of claim 1 wherein the potential winning event is at least one potential winning event from a group of potential winning events consisting of: a selected team who has a no-hitter in a single game; a selected team achieving a selected non-final score over another team in a selected time period of a selected game; a selected team having a 13 numerical event and winning the game; a selected team achieving a selected point spread in a non-final score of a game; and a selected team achieving a selected point spread in the final score of a game.

8. A process of claim 1 wherein the potential winning event is at least one winning event selected from a group of winning events consisting of: the selected team to win by exactly 13 points, the selected team who wins with 13 hits, the selected team who wins with 13 runs, the selected team who wins with 13 home runs.

9. A process of claim 1 wherein the potential winning event for a round based wagered upon sporting event is one of a group of potential winning events consisting of: a selected first player winning the selected round, a selected second player winning the selected round, a draw occurring between the two players in the selected round.

10. A process of claim 1 (inning) wherein the potential winning event is the selection of a winner of at least one event of progressive sub-championship events.

11. A process of claim 1 wherein at least a portion of the common wager pool is rolled over to the next wagered upon sporting event.

12. A process of claim 1 wherein the determining that at least one selected gaming square represents an actual winning occurrence is based on the score represented by the selected gaming square closely matching the actual winning score of the wagered upon sporting event.

13. A system for sports square wagering comprising:
a) a wager format, the wager format with a display showing least one grid having at least two axes with intersecting rows and columns forming a plurality of gaming squares, each gaming square representing a potential winning event for the wagered upon sporting event; selected gaming squares transmitting wager information to a wager processing capability; and
b) the wager processing center, the wager processing center comprising of at least one a common wager pool for receiving funds from wagers placed upon the wagered upon sport; the ability to determine winning wagers; and the ability to issue payouts from the common wager pool for winning wagers based on selected gaming squares.

14. A system of claim 10 wherein the grid has at least three rows, with one row representing a first player winning a round of the wagered upon sport, a second row representing a second player winning a round of the wagered upon sport, a third row representing a tie between the first player and the second player.

15. A system of claim 10 wherein the grid has at least three columns, one column representing the selection of one winning team, a second column representing the selection of another winning team, and the third column could be representing possible sub-events that could occur in a game and in which the selected team wins the game.

16. A system of claim 10 wherein the wagered upon sporting event is at least a series of games played between two teams.

17. A system for sports square wagering of claim 10 wherein the grid may have its gaming squares distinguished as above gaming squares, center diagonal gaming squares, below gaming squares.

18. A system of claim 17 wherein the center diagonal gaming squares and below gaming squares have different winning payout odds than the above gaming squares

19. An apparatus for pari-mutuel type gambling comprising:
a. wager format means for communicating wagers placed upon a wagered upon sporting event using a grid that displays gaming squares representing potential winning events of a wagered upon sporting event;
b. a process means for collecting and tabulating winning wagers for the wagered upon sporting event, and
c. a common wager pool means for holding wagered funds and for paying out winning wagers as tabulated by the process means.

20. An apparatus of claim 17 wherein the wager format means further comprises an advertising means.
